(19) United States
(12) Patent Application Publication
(10) Pub. No.: US 2025/0223462 A1
(43) Pub. Date: Jul. 10, 2025

(54) ELECTRONIC COMPONENT

(71) Applicant: Nihon Parkerizing Co., Ltd., Tokyo (JP)

(72) Inventors: Yuta Kobayashi, Tokyo (JP); Daisuke Wachi, Tokyo (JP); Hiroaki Ariyoshi, Tokyo (JP); Kaori Ozawa, Tokyo (JP)

(21) Appl. No.: 18/853,176

(22) PCT Filed: Apr. 3, 2023
(86) PCT No.: PCT/JP2023/013781

§ 371 Date: Oct. 1, 2024

(30) Foreign Application Priority Data
Apr. 7, 2022 (JP) 2022-063743

(51) Int. Cl. C09D 163/00; C08G 59/24; C08G 59/32; C08G 59/38; C08G 59/40; H01B 3/40

(52) U.S. Cl. CPC C09D 163/00; C08G 59/245; C08G 59/3218; C08G 59/38; C08G 59/4064; H01B 3/40

(57) ABSTRACT

The present invention addresses the problem of providing an electronic component having excellent high-temperature durability. The problem is solved by an electronic component including a metal part and a film on the entirety or a portion of the metal part, in which the film contains a specific anionic epoxy resin or a salt thereof.

### TECHNICAL FIELD

The present invention relates to an electronic component.

### BACKGROUND ART

In recent years, studies have been conducted on the formation of an excellent film on a metal material with the use of a surface treatment agent containing a specific resin. For example, Patent Document 1 discloses that a film having excellent edge covering properties and insulating properties can be formed by surface-treating a metal material with a surface treatment agent containing, for example, an anionic epoxy resin having a specific structure.

Meanwhile, the environments in which electronic components are used in various products have been increasingly diversified. Under this circumstance, electronic components are required to satisfy high durability in their use environments. Patent Document 2 discloses that an electronic component excellent in moisture resistance, chemical resistance, and the like can be obtained by, in an electronic component that includes an insulator containing a metal magnetic powder, forming a resin coating film on the insulator.

### RELATED ART DOCUMENTS

### Patent Documents

[Patent Document 1] Japanese Unexamined Patent Application Publication No. 2019-116552
[Patent Document 2] WO 2016/013643

### SUMMARY OF THE INVENTION

### Problems to be Solved by the Invention

As described above, electronic components are required to satisfy high durability in their use environments. For example, electronic components used in automobiles and the like are required to maintain their performance, such as insulating properties, over an extended period even in a high-temperature environment (high-temperature durability). The electronic component disclosed in Patent Document 2, on which a coating film is formed, has room for improvement in terms of the high-temperature durability. An object of the present invention is to provide an electronic component that is excellent in the high-temperature durability.

### Means for Solving the Problems

The present invention encompasses, for example, the following.

[1] An electronic component, including:
a metal part; and
a film on the entirety or a portion of the metal part,
wherein the film contains an anionic epoxy resin or a salt thereof, which contains a structural unit represented by the following Formula (1), at least one of structural units represented by the following Formulae (2) and (3), and at least one of structural units represented by the following Formulae (4) and (5):

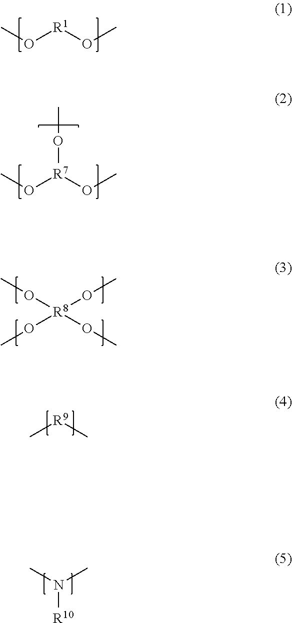

[in Formula (1), R¹ represents a structure represented by the following Formula (1a), (2a), or (3a); in Formula (2), R⁷ represents a structure represented by the following Formula (4a) or (5a); in Formula (3), R⁸ represents a structure represented by the following Formula (6a) or (7a); in Formula (4), R⁹ represents a structure represented by the following Formula (8a) or (9a); and, in Formula (5), R¹⁰ represents a structure represented by the following Formula (10a) or (11a)]

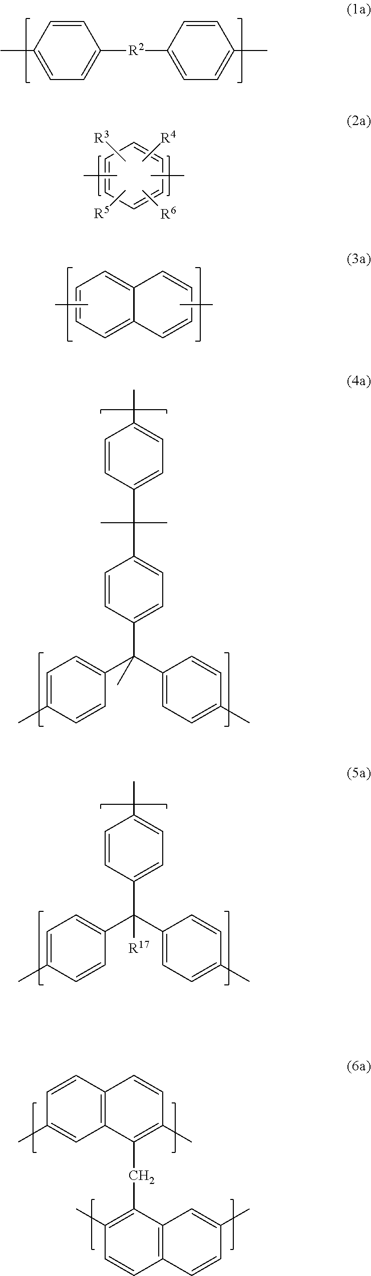

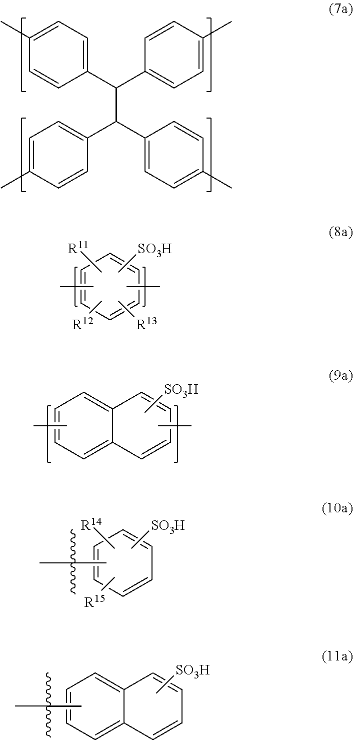

[in Formula (1a), R² represents a single bond, C(CH₃)₂, CH(CH₃), CH₂, S, O, or SO₂; in Formula (2a), R³ to R⁶ each independently represent a hydrogen atom, a methyl group, an alkylcarbonyl group, an alkoxy group, or an alkoxycarbonyl group; in Formula (5a), R¹⁷ represents a hydrogen atom or an alkyl group; in Formula (8a), R¹¹ to R¹³ each independently represent a hydrogen atom, a methyl group, or an alkoxy group; and, in Formula (10a), R¹⁴ and R¹⁵ each independently represent a hydrogen atom, a methyl group, or an alkoxy group].

[2] The electronic component according to [1], which is selected from the group consisting of an electronic component, a bus bar, a reactor, an electric wire, and a sintered magnet, which constitute a motor.

### Effects of the Invention

According to the present invention, an electronic component that includes a film having excellent high-temperature durability can be obtained.

### MODE FOR CARRYING OUT THE INVENTION

The electronic component according to one embodiment of the present invention, which includes a film on the entirety or a portion of a metal part, and a method of producing the same will now be described.

### <Electronic Component>

An electronic component that can be used in the present embodiment is not particularly limited as long as it includes a metal part and the entirety or a portion of the surface is composed of a metal. Examples of the type of the electronic component include electronic components (e.g., stators, rotors, and lead wires), bus bars, reactors, electric wires, and sintered magnets, which constitute motors.

Examples of the metal constituting the entirety or a portion of the surface of the electronic component include, but not particularly limited to, iron, iron alloys, aluminum, aluminum alloys, copper, and copper alloys. The metal may be configured to be in the form of a film on the entirety or a portion of the surface of the electronic component. Specific examples of the film of the metal include those films formed by a sputtering method, a CVD method, a laser deposition method, an ink-jet method, a pattern plating transfer method, a damascene method, or the like on the surfaces of materials, such as various metal materials (including alloy materials); ceramics; glasses; resin films; and wafers of silicon, silicon carbide (SiC), sapphire, glass, gallium phosphide (GaP), gallium arsenide (GaAs), indium phosphide (InP), gallium nitride (GaN), and the like. Other film (e.g., a film of titanium or a titanium alloy) may also be formed between any of the above-described materials and the film of the metal by a vapor deposition method, a sputtering method, or the like. The titanium alloy is not particularly limited as long as it contains titanium and a metal element other than titanium, with titanium being contained in the largest amount. Specific examples of the titanium alloy include titanium-palladium alloys, titanium-nickel-chromium-ruthenium-palladium alloys, titanium-tantalum alloys, titanium-palladium-cobalt alloys, titanium-nickel-ruthenium alloys, titanium-aluminum alloys, and titanium-aluminum-vanadium alloys, which are prescribed in JIS H4600:2012.

A size of the metal part of the electronic component is not particularly limited and varies depending on the type of the electronic component, and the electronic component is not a large component such as an automobile body.

The size of the electronic component may be, for example, 1 mm or more, 10 mm or more, but 1,000 mm or less, 500 mm or less, or 300 mm or less, in terms of the major axis.

Specific examples of the above-described electronic component include the following.

WO 2019/077793 discloses a stator coil which includes an insulating cover material (6) composed of: a mica layer (7) containing mica; and a reinforcing layer (8) that is laminated on the mica layer (7) and contains filler particles (10) and a reinforcing material (11). The film according to the present embodiment can be applied to this stator coil.

Japanese Unexamined Patent Application Publication No. 2019-116552 discloses an insulating sheet 1 which fills a gap between a stator core 12 and a stator coil 11 and thereby insulates and adheres these members. The film according to the present embodiment can be applied to fill the gap between the stator core 12 and the stator coil 11.

In Japanese Unexamined Patent Application Publication No. 2020-114179, with regard to a collar 13 and a coil end 12a which are provided in a stator 10 of a rotary electric machine, it is described that an elastic object (e.g., an insulating paper) can be arranged between an outer periphery 13c of the collar 13 and an inner periphery 12b of the coil end 12a. The film according to the present embodiment can be applied as the elastic object.

In Japanese Unexamined Patent Application Publication No. 2019-6924, with regard to a stator 20 which includes a stator core 21, a large number of slots 15 arranged on an inner peripheral part of the stator core 21, and a stator coil 60 wound on the slots 15, it is described to cover the stator coil 60 with a cured product of a resin composition for electric equipment insulation. Further, in Japanese Unexamined Patent Application Publication No. 2016-124878, it is described to cover the stator coil 60 with a resin composition 601. The film according to the present embodiment can be applied to the stator coil 60.

Japanese Unexamined Patent Application Publication No. 2015-171249 describes that insulation coating is performed on a stator core 11 used in a stepping motor 10. The film according to the present embodiment can be applied to the stator core 11.

Japanese Unexamined Patent Application Publication No. 2021-60263 discloses a double redundant system resolver in which only one annular stator (10) having a large number of protruding magnetic poles (13) is used. It is described that, in this double redundant system resolver, gaps between divided cores (21), each of which is formed of a pair of the protruding magnetic poles (13) as a single component, are insulated by a non-magnetic material (20). The film according to the present embodiment can be applied as the non-magnetic material (20) between the divided cores (21).

In Japanese Unexamined Patent Application Publication No. 2020-18080, it is described that, on the entire surfaces of an annular stator 1 and magnetic poles 2, an annular insulating cap 4 used for obtaining insulation between these members and a stator winding 10 wound on each magnetic pole 2 is formed. The film according to the present embodiment can be applied as the annular insulating cap 4.

In Japanese Unexamined Patent Application Publication No. 2020-145854, it is described that, in a stator which includes a motor core having plural core parts arranged in an annular shape and air-core coils inserted into the core parts, an insulating paper is arranged between the respective core parts and air-core coils. The film according to the present embodiment can be applied in place of the insulating paper.

WO 2021/153540 discloses a motor stator 30 which is formed by superposing electromagnetic steel sheets and includes a stator core 31, an insulator 34, and an excitation coil 35. The film according to the present embodiment can be applied as the insulator 34.

The motor disclosed in Japanese Unexamined Patent Application Publication No. 2021-118674 is described to, as a desired aspect, include an insulating material that insulates a stator core and a motor winding. The film according to the present embodiment can be applied as the insulating material.

In Japanese Unexamined Patent Application Publication No. 2020-102898, it is described that a coil part 20 constituting a stator 100 is formed by bonding plural rectangular conductive wires 20a with one another, and that the rectangular conductive wires 20a are each formed such that the periphery of a conductive member 20b is covered with an insulating film 20c. The film according to the present embodiment can be applied as the insulating film 20c.

In Japanese Unexamined Patent Application Publication No. 2021-52462, it is described that a resin film 14 is formed on the outer circumferential surface of a cylindrical covering member 13 of a rotor 10. The film according to the present embodiment can be applied as the resin film 14.

In Japanese Unexamined Patent Application Publication No. 2019-176616, it is described that a stationary part 3 of a motor MT includes a plate-like wiring member 36 and a conductive member (lead wire) 306 through which an electric current flows, and that the lead wire has a cover formed of an insulator. The film according to the present embodiment can be applied as the cover formed of an insulator.

Japanese Unexamined Patent Application Publication No. 2021-89890 discloses an inter-terminal connection structure in which terminal portions of plural devices are connected to each other in an electrically conductive state via a conductive member arranged between the terminal portions. The film according to the present embodiment can be applied to a bus bar 56, a bolt 84, and the like that are used in a conductive component 54 of the inter-terminal connection structure.

Japanese Unexamined Patent Application Publication No. 2021-48001 discloses a bus bar having an insulating layer (insulated bus bar 10) that is used as a wiring member for transmission of electric current in a power conversion device such as an inverter or a converter. The film according to the present embodiment can be applied as an insulating layer 2 of the insulated bus bar.

Japanese Unexamined Patent Application Publication No. 2021-57139 discloses a bus bar assembly including first and second bus bars which are arranged in the same plane with a gap existing therebetween, and are connected in an insulated state by an insulating resin layer that includes a gap filling part filled into the gap. It is described that INSULEED (registered trademark) is preferably utilized as an insulating resin material that forms an insulating resin layer 30 of the bus bar assembly. The film according to the present embodiment can be applied as the insulating resin material.

Japanese Unexamined Patent Application Publication No. 2019-153501 discloses an insulated flat rectangular conductor which includes a flat rectangular conductor and an insulating film covering the flat rectangular conductor, and also discloses a coil in which the insulated flat rectangular conductor is used. The film according to the present embodiment can be applied as the insulating film.

In Japanese Unexamined Patent Application Publication No. 2019-197779, it is described that a conductive wire 10 of a coil 1 constituting a reactor is covered with an insulating material. The film according to the present embodiment can be applied as a cover formed of the insulating material.

Japanese Unexamined Patent Application Publication No. 2019-87540 discloses an insulated electric wire for railway vehicles. The insulated electric wire is configured such that plural layers are arranged on the outer periphery of a conductor 110. The film according to the present embodiment can be applied as, among the plural layers, a semi-conductive layer 130 that is in contact with the conductor 110.

Japanese Unexamined Patent Application Publication No. 2019-117793 discloses an insulated electric wire and a cable that are used for internal wiring of electronic devices. This insulated electric wire is composed of a conductor and an insulating layer that is coated on the outer periphery of the conductor and formed of a vinyl chloride composition, and the film according to the present embodiment can be applied as the insulating layer.

Japanese Unexamined Patent Application Publication No. 2019-106387 discloses a multilayer insulated electric wire and a multilayer insulated cable that are applied to railway vehicles, automobiles, instruments, and the like. A two-layer insulated electric wire 10, which is one embodiment of the multilayer insulated electric wire, includes a conductor 11, an insulating inner layer 12 coated on the conductor 11, and an insulating outer layer 13 coated on the insulating inner layer 12, and the film according to the present embodiment can be applied as the insulating inner layer 12.

Japanese Unexamined Patent Application Publication No. 2021-111448 discloses an enamel wire used in motors, such as industrial motors. This enamel wire is composed of a conductor and an insulating film, and the film according to the present embodiment can be applied as the insulating film.

Japanese Unexamined Patent Application Publication No. 2021-141011 discloses an electric coil used in various electric instruments, such as motors and transformers. An insulated copper wire is wound on the electric coil, and this insulated copper wire includes a copper wire and an insulating film covering the surface of the copper wire. The film according to the present embodiment can be applied as the insulating film covering the surface of the copper wire.

Japanese Unexamined Patent Application Publication No. 2020-161410 discloses an insulated electric wire used in coils and the like of vehicle motors. The insulated electric wire includes a conductive part 1 having plural element wires 11, and an insulating layer 2 covering the outer periphery of the conductive part 1. The film according to the present embodiment can be applied as the insulating layer 2.

Japanese Unexamined Patent Application Publication No. 2021-153109 discloses a sintered magnet used in products, such as motors for household electric appliances and industrial use, driving motors of electric vehicles (EVs) and hybrid electric vehicles (HEVs), and motors for electric power steering (EPS). It is described that the sintered magnet may be subjected to a surface treatment with a resin paint, and the film according to the present embodiment can be applied as the surface treatment.

### <Film>

The electronic component according to the present embodiment includes a metal part, and a film on the entirety or a portion of the metal part. The film contains an anionic epoxy resin (hereinafter, referred to as “resin”) or a salt thereof. The film allows the electronic component according to the present embodiment to have improved high-temperature durability and an extended life, as a result of which effective utilization of resources can be achieved.

### <Resin or Salt Thereof>

The resin according to the present embodiment contains a structural unit represented by the following Formula (1), at least one of structural units represented by the following Formulae (2) and (3), and at least one of structural units represented by the following Formulae (4) and (5):

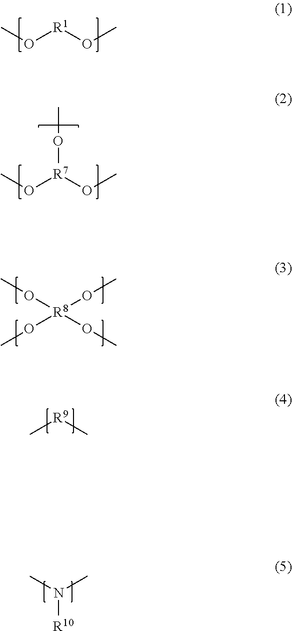

Examples of a combination of structural units in the resin include: a combination of structural units of Formulae (1), (2), and (4); a combination of structural units of Formulae (1), (2), and (5); a combination of structural units of Formulae (1), (3), and (4); a combination of structural units of Formulae (1), (3), and (5); a combination of structural units of Formulae (1), (2), (3), and (4); a combination of structural units of Formulae (1), (2), (3), and (5); a combination of structural units of Formulae (1), (2), (4), and (5); a combination of structural units of Formulae (1), (3), (4), and (5); and a combination of structural units of Formulae (1), (2), (3), (4), and (5).

In Formula (1), R¹ represents a structure represented by the following Formula (1a), (2a), or (3a):

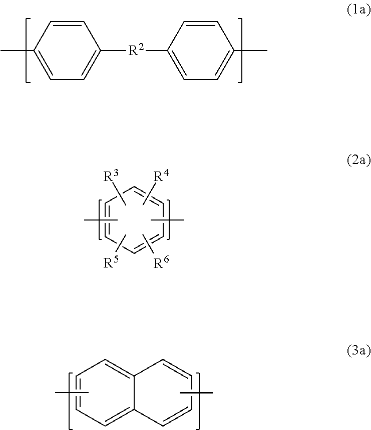

When R¹ is Formula (1a), R² in Formula (1a) represents a single bond, C(CH₃)₂, CH(CH₃), CH₂, S, O, or SO₂. When R¹ is Formula (2a), R³ to R⁶ in Formula (2a) each independently represent a hydrogen atom, a methyl group, an alkylcarbonyl group, an alkoxy group, or an alkoxycarbonyl group. It is noted here that, as the structural unit of Formula (1), any one of, or two or more of these structural units may be contained in the resin.

In Formula (2), R⁷ represents a structure represented by the following Formula (4a) or (5a):

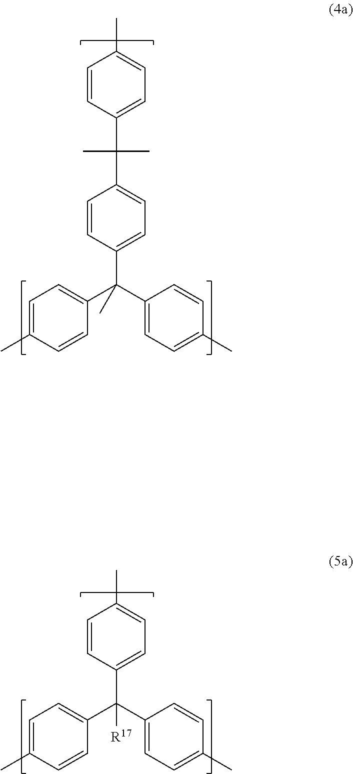

When R⁷ is Formula (5a), R¹⁷ in Formula (5a) represents a hydrogen atom or an alkyl group. It is noted here that, as the structural unit of Formula (2), either one of, or both of these structural units may be contained in the resin.

In Formula (3), R³ represents a structure represented by the following Formula (6a) or (7a):

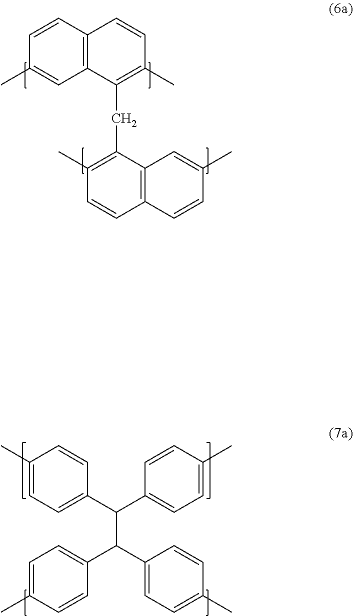

It is noted here that, as the structural unit of Formula (3), either one of, or both of these structural units may be contained in the resin.

In Formula (4), R⁹ represents a structure represented by the following Formula (8a) or (9a):

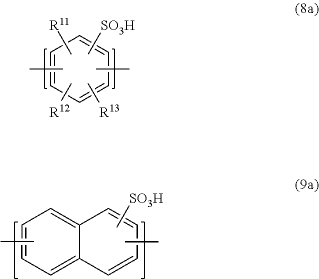

When R⁹ is Formula (8a), R¹¹ to R¹³ in Formula (8a) each independently represent a hydrogen atom, a methyl group, or an alkoxy group. It is noted here that, as the structural unit of Formula (4), any one of, or two or more of these structural units may be contained in the resin.

In Formula (5), R¹⁰ represents a structure represented by the following Formula (10a) or (11a):

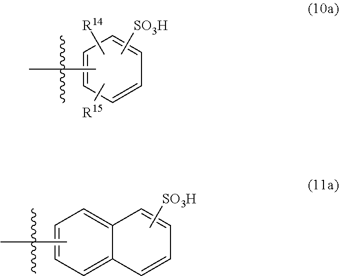

When R¹⁰ is Formula (10a), R¹⁴ and R¹⁵ in Formula (10a) each independently represent a hydrogen atom, a methyl group, or an alkoxy group. Preferably, R¹⁴ and R¹⁵ are hydrogen atoms. It is noted here that, as the structural unit of Formula (5), any one of, or two or more of these structural units may be contained in the resin.

The above-described resin may further contain a structural unit represented by the following Formula (6):

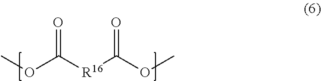

In Formula (6), R¹⁶ represents an alkylene group having 1 to 20 carbon atoms. The alkylene group may have one or more substituents of a single kind that are selected from alkyl groups, alkenyl groups, alkadienyl groups, and a methylene group, or may have one or more substituents of each of two or more kinds that are selected from alkyl groups, alkenyl groups, alkadienyl groups, and a methylene group. When R¹⁶ is an alkylene group having 2 to 20 carbon atoms, a ring may be formed via adjacent carbon atoms of the alkylene group. The ring may have one or more substituents selected from alkyl groups and alkenyl groups, preferably two substituents that are an alkyl group(s) and/or an alkenyl group(s). When the ring has two substituents, the two substituents may be the same or different. Examples of the ring include a cyclohexane ring, a cyclohexene ring, a benzene ring, and a bicyclo ring (e.g., bicyclo[4.4.0]decane-1,7-diene) in which two carbon-carbon bonds of a decalin ring are double bonds.

More preferably, the alkylene group has 2 to 18 carbon atoms and contains one methylene group, one or two alkyl groups having 5 to 9 carbon atoms, or two substituents of one or two kinds that are selected from alkyl, alkenyl, and alkadienyl groups having 5 to 9 carbon atoms; or the alkylene group has 2 to 18 carbon atoms and forms any of the above-described rings via adjacent carbon atoms, and the ring optionally has two substituents that are each independently an alkyl, alkenyl, or alkadienyl group having 5 to 9 carbon atoms.

The alkylene group may be linear or branched. Examples of the alkylene group include alkylene groups having 1 to 20 carbon atoms, more specifically alkylene groups having 1 to 12 carbon atoms, such as a methylene chain, an ethylene chain, a propylene chain, a butylene chain, a pentylene chain, a hexylene chain, a heptylene chain, an octylene chain, a nonylene chain, a decylene chain, an undecylene chain, and a dodecylene chain.

The above-described alkyl groups, as well as those alkyl groups in the alkylcarbonyl group, the alkoxy group, and the alkoxycarbonyl group may be linear or branched. Examples of these alkyl groups include alkyl groups having 1 to 20 carbon atoms, more specifically alkyl groups having 1 to 12 carbon atoms, such as a methyl group, an ethyl group, a propyl group, a butyl group, a pentyl group, a hexyl group, a heptyl group, an octyl group, a nonyl group, a decyl group, an undecyl group, and a dodecyl group.

The above-described alkenyl groups may be linear or branched. Examples of the alkenyl groups include alkenyl groups having 2 to 20 carbon atoms, more specifically alkenyl groups having 2 to 12 carbon atoms, such as an ethenyl group, a propenyl group, a butenyl group, a pentenyl group, a hexenyl group, a heptenyl group, an octenyl group, a nonenyl group, a decenyl group, an undecenyl group, and a dodecenyl group.

The above-described alkadienyl groups may be linear or branched. Examples of the alkadienyl groups include, but are not limited to, alkenyl groups having 4 to 10 carbon atoms, such as a butadienyl group, a pentadienyl group, a hexadienyl group, a heptadienyl group, an octadienyl group, a nonadienyl group, and a decadienyl group.

It is noted here that, as the structural unit of Formula (6), any one of, or two or more of the above-described structural units may be contained in the resin.

The resin according to the present embodiment has a weight-average molecular weight of usually in a range of 1,000 to 1,000,000, preferably in a range of 20,000 to 100,000. In the present specification, the weight-average molecular weight is a value that is measured by GPC (gel-permeation chromatography) and calculated in terms of polystyrene.

Examples of a salt of the resin according to the present embodiment include: alkali metal salts, such as sodium salts and potassium salts; ammonium salts; alkanolamine salts, such as monoethanolamine salts, diethanolamine salts, triethanolamine salts, methylethanolamine salts, and dimethylethanolamine salts; alkylamine salts, such as tetramethylamine salts and tetraethylamine salts; benzylamine salts, such as methylbenzylamine salts and dimethylbenzylamine salts; and alicyclic amine salts, such as pyrrolidine salts and piperidine salts.

### <Method of Producing Resin or Salt Thereof>

The resin or salt thereof according to the present embodiment can be produced by, in accordance with a combination of structural units in the resin or the salt, blending as appropriate a compound having a structural unit represented by Formula (1) (hereinafter, referred to as “compound (1)”), a compound having a structural unit represented by Formula (2) (hereinafter, referred to as “compound (2)”), a compound having a structural unit represented by Formula (3) (hereinafter, referred to as “compound (3)”), a compound having a structural unit represented by Formula (4) (hereinafter, referred to as “compound (4)”), a compound having a structural unit represented by Formula (5) (hereinafter, referred to as “compound (5)”), and the like in an organic solvent, further blending a compound having a structural unit represented by Formula (6) (hereinafter, referred to as “compound (6)”) if necessary, and then performing a polymerization reaction at a prescribed temperature. It is noted here that, if necessary, a reaction catalyst may be further blended to perform the polymerization reaction. The temperature of the polymerization reaction is not particularly limited; however, it is usually in a range of 70° C. to 200° C. The reaction time is also not particularly limited; however, it is usually in a range of 10 minutes to 24 hours.

Examples of the compound (1) include: a dihydroxy compound in which a hydrogen atom is bound to both ends of the structural unit represented by Formula (1); a diglycidyl ether compound in which a glycidyl group is bound to both ends of the structural unit represented by Formula (1); a reaction product obtained by allowing a hydroxy group(s) on one or both ends of the dihydroxy compound to react with epoxy groups of a polyglycidyloxy compound having two or more glycidyloxy groups; and a reaction product obtained by allowing an epoxy group(s) on one or both ends of the diglycidyl ether compound to react with hydroxy groups of a polyol compound having two or more hydroxy groups.

Examples of the diglycidyl ether compound include compounds in which hydrogen atoms of hydroxy groups on both ends of bisphenol A, bisphenol E, bisphenol F, catechol, resorcinol, hydroquinone, 1,6-dihydroxynaphthalene, or the like are substituted with glycidyl groups.

Examples of the dihydroxy compound include: bisphenol compounds, such as bisphenol A, bisphenol E, bisphenol F, bis(4-hydroxyphenyl)sulfide, 2,2′-dihydroxydiphenyl ether, and 4,4′-dihydroxybiphenyl; dihydroxybenzene compounds, such as catechol, 3-methylcatechol, 4-methylcatechol, 3-methoxycatechol, 3′,4′-dihydroxyacetophenone, ethyl 3,4-dihydroxybenzoate, methyl 2,3-dihydroxybenzoate, methyl 3,4-dihydroxy-2-methyl benzoate, 2′,3′-dihydroxy-4′-methoxyacetophenone, resorcinol, 5-methoxyresorcinol, 2-methylresorcinol, 5-methylresorcinol, 3′,5′-dihydroxyacetophenone, 2′,6′-dihydroxyacetophenone, 2′,4′-dihydroxyacetophenone, methyl 3,5-dihydroxybenzoate, methyl 2,6-dihydroxybenzoate, methyl 3,5-dihydroxy-4-methoxybenzoate, ethyl 2,4-dihydroxy-6-methoxybenzoate, hydroquinone, methylhydroquinone, methoxyhydroquinone, 2′,5′-dihydroxyacetophenone, 2,3-dimethylhydroquinone, 2,6-dimethylhydroquinone, trimethylhydroquinone, and tetramethylhydroquinone; and dihydroxynaphthalenes, such as 2,3-dihydroxynaphthalene, 1,6-dihydroxynaphthalene, 2,6-dihydroxynaphthalene, 2,7-dihydroxynaphthalene, 1,5-dihydroxynaphthalene, 1,8-dihydroxynaphthalene, 1,2-dihydroxynaphthalene, and 1,4-dihydroxynaphthalene.

Examples of the polyglycidyloxy compound include diglycidyl ether compounds, as well as succinic acid diglycidyl ester, adipic acid diglycidyl ester, sebacic acid diglycidyl ester, ethylene glycol diglycidyl ether, 1,3-propylene glycol diglycidyl ether, 1,4-butanediol diglycidyl ether, 1,6-hexanediol diglycidyl ether, sorbitol polyglycidyl ether, resorcinol diglycidyl ether, polyalkylene glycol diglycidyl ether, glycerol triglycidyl ether, trimethylolethane triglycidyl ether, trimethylolpropane triglycidyl ether, pentaerythritol tetraglycidyl ether, and triglycidyl ethers of glycerol alkylene oxide adducts. It is noted here that, as the polyglycidyloxy compound, for example, the below-described triglycidyl ether compound or tetraglycidyl ether compound may be used as well.

Examples of the polyol compound include dihydroxy compounds, as well as ethylene glycol, propylene glycol, tetraethylene glycol, 1,5-pentanediol, 1,6-hexanediol, 1,7-heptanediol, 1,8-octanediol, 1,9-nonanediol, 1,10-decanediol, neopentyl glycol, 2-methyl-1,3-propanediol, 3-methyl-1,5-pentanediol, cyclohexyl dimethanol, and 1,3-adamantanediol. It is noted here that, as the polyol compound, for example, the below-described trihydroxy compound or tetrahydroxy compound may be used as well.

Examples of the compound (2) include: a trihydroxy compound in which a hydrogen atom is bound to three ends of the structural unit represented by Formula (2); a triglycidyl ether compound in which a glycidyl group is bound to three ends of the structural unit represented by Formula (2); a reaction product obtained by allowing one or more hydroxy groups of the trihydroxy compound to react with epoxy groups of the above-described polyglycidyloxy compound; and a reaction product obtained by allowing one or more epoxy groups of the triglycidyl ether compound to react with hydroxy groups of the above-described polyol compound.

Examples of the triglycidyl ether compound include compounds in which hydrogen atoms of hydroxy groups on three ends of α,α,α′-tris(4-hydroxyphenyl)-1-ethyl-4-isopropylbenzene, 1,1,1-tris(4-hydroxyphenyl)ethane, tris(4-hydroxyphenyl)methane, or the like are substituted with glycidyl groups.

Examples of the trihydroxy compound include α,α,α′-tris(4-hydroxyphenyl)-1-ethyl-4-isopropylbenzene, 1,1,1-tris(4-hydroxyphenyl)ethane, and tris(4-hydroxyphenyl)methane.

Examples of the compound (3) include: a tetrahydroxy compound in which a hydrogen atom is bound to four ends of the structural unit represented by Formula (3); a tetraglycidyl ether compound in which a glycidyl group is bound to four ends of the structural unit represented by Formula (3); a reaction product obtained by allowing one or more hydroxy groups of the tetrahydroxy compound to react with epoxy groups of the above-described polyglycidyloxy compound; and a reaction product obtained by allowing one or more epoxy groups of the tetraglycidyl ether compound to react with hydroxy groups of the above-described polyol compound.

Examples of the tetraglycidyl ether compound include compounds in which hydrogen atoms of hydroxy groups on four ends of 1,1,2,2-tetrakis(4-hydroxyphenyl)ethane, 1,1′-methylene-bis(2,7-naphthalenediol), or the like are substituted with glycidyl groups.

Examples of the tetrahydroxy compound include 1,1,2,2-tetrakis(4-hydroxyphenyl)ethane and 1,1′-methylene-bis(2,7-naphthalenediol).

Examples of the compound (4) include: compounds in which hydroxy groups or amino groups are bound to both ends of the structural unit represented by Formula (4), and salts thereof; and compounds in which a hydroxy group is bound to one end of the structural unit represented by Formula (4) and an amino group is bound to the other end, and salts thereof. More specific examples of the compound (4) include: compounds such as hydroquinone sulfonic acid, 4,6-dihydroxynaphthalene-2-sulfonic acid, 2,3-dihydroxynaphthalene-6-sulfonic acid, 3-amino-4-hydroxybenzenesulfonic acid, 6-amino-1-hydroxy-3-naphthalenesulfonic acid, 6-amino-4-hydroxy-2-naphthalenesulfonic acid, 5-amino-1-hydroxy-3-naphthalenesulfonic acid, 1-amino-2-hydroxy-4-naphthalenesulfonic acid, 2,5-diaminobenzenesulfonic acid, 2,4-diaminobenzenesulfonic acid, 3,5-diamino-2,4,6-trimethylbenzenesulfonic acid, and 3,4-diaminonaphthalene-1-sulfonic acid; and salts thereof.

Examples of the compound (5) include compounds in which hydrogen atoms are bound to both ends of the structural unit represented by Formula (5), and salts thereof. More specific examples of the compound (5) include: compounds such as 3-aminobenzenesulfonic acid, 4-aminobenzenesulfonic acid, 2,4-dimethylaniline-5-sulfonic acid, 2-aminobenzenesulfonic acid, 4-aminotoluene-3-sulfonic acid, 4-methoxyaniline-2-sulfonic acid, 2-amino-3,5-dimethylbenzenesulfonic acid, 5-aminotoluene-2-sulfonic acid, 4-amino-3-methylbenzenesulfonic acid, 2-amino-1-naphthalenesulfonic acid, and 4-amino-1-naphthalenesulfonic acid; and salts thereof.

Examples of the salts of the compound (4) or the salts of the compound (5) include: alkali metal salts, such as sodium salts and potassium salts; ammonium salts; alkanolamine salts, such as monoethanolamine salts, diethanolamine salts, triethanolamine salts, methylethanolamine salts, and dimethylethanolamine salts; alkylamine salts, such as tetramethylamine salts and tetraethylamine salts; benzylamine salts, such as methylbenzylamine salts and dimethylbenzylamine salts; and alicyclic amine salts, such as pyrrolidine salts and piperidine salts.

Examples of the compound (6) include dicarboxylic acid compounds in which hydrogen atoms are bound to both ends of the structural unit represented by Formula (6).

More specific examples of the dicarboxylic acid compounds include malonic acid, succinic acid, glutaric acid, 2,2-dimethylglutaric acid, 3,3-dimethylglutaric acid, adipic acid, 2,2-dimethyladipic acid, pimelic acid, suberic acid, azelaic acid, 2-ethylazelaic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetradecanedicarboxylic acid, 1,15-pentadecanedicarboxylic acid, 1,16-hexadecanedicarboxylic acid, 1,17-heptadecanedicarboxylic acid, 1,18-octadecanedicarboxylic acid, 1,19-nonadecanedicarboxylic acid, 1,20-icosanedicarboxylic acid, itaconic acid, phthalic acid, dimer acids, 1,2-cyclohexanedicarboxylic acid, and 1,2-cyclohexenedicarboxylic acid. Examples of the dimer acids include commercially available dimer acids, such as HARIDIMER 200, 250, and 270S (which are manufactured by Harima Chemicals Group, Inc.); TSUNODIME 205, 216, 228, 395, and 346 (which are manufactured by Tsuno Co., Ltd.); UNYDYME 14, 14R, T-17, 18, T-18, 22, T-22, 27, 35, M-9, M-15, M-35, and 40, CENTURY D-75, D-77, D-78, and D-1156, as well as SYLVATAL 7001 and 7002 (which are manufactured by Arizona Chemical Holdings Corporation); EMPOL 1016, 1003, 1026, 1028, 1061, 1062, 1008, and 1012 (which are manufactured by BASF Japan Ltd.); and hydrogenated dimer acids (average Mₙ=˜570; manufactured by Sigma-Aldrich Co., LLC).

The amount of each of the compounds (1) to (6) to be blended may be set as appropriate in accordance with the ratio of each structural unit in a resin that can be produced.

The organic solvent is not particularly limited as long as it can dissolve the compounds (1) to (6) and, for example, any of the following can be used: glycol ether-based organic solvents, such as ethylene glycol ethyl ether, ethylene glycol-n-butyl ether, diethylene glycol ethyl ether, and propylene glycol methyl ether; ketone-based organic solvents, such as methyl ethyl ketone and methyl isobutyl ketone; and amide-based organic solvents, such as dimethylformamide, dimethylacetamide, and N-methyl-2-pyrrolidone. These organic solvents may be used singly, or in combination of two or more kinds thereof.

The reaction catalyst is not particularly limited as long as it can accelerate the above-described polymerization reaction and, for example, any of the following can be used: tertiary amines, such as dimethylbenzylamine, triethylamine, and tributylamine; and quaternary ammonium salts, such as tetraethylammonium bromide and tetrabutylammonium bromide. These reaction catalysts may be used singly, or in combination of two or more kinds thereof.

Whether or not each structural unit represented by Formula (1), Formula (2), Formula (3), Formula (4), Formula (5), Formula (6), or the like is contained in the resin produced in the above-described manner can be confirmed by measuring ¹H NMR and/or ¹³C NMR using a nuclear magnetic resonance apparatus.

The resin or salt thereof contained in the film according to the present embodiment may be in its original form, or in the form of a cross-linked product. The resin or salt thereof may also be in the form of being cross-linked with a curing agent such as a polyisocyanate compound.

Examples of the polyisocyanate compound include tolylene diisocyanate, xylylene diisocyanate, phenylene diisocyanate, diphenylmethane-2,4′-diisocyanate, diphenylmethane-4,4′-diisocyanate, polymeric MDI (crude MDI: polymethylene polyphenyl polyisocyanate), bis(isocyanate methyl)cyclohexane, tetramethylene diisocyanate, hexamethylene diisocyanate, methylene diisocyanate, and isophorone diisocyanate. These polyisocyanate compounds may be used singly, or in combination of two or more kinds thereof.

The film according to the present embodiment may also contain a cation of an element constituting the metal part of the electronic component. In cases where the below-described surface treatment agent contains an acid and/or an oxidizing agent, the metal part of the electronic component is etched when the electronic component comes into contact with the surface treatment agent, and the resulting cation of the element constituting the metal part is incorporated into the film.

A thickness of the film according to the present embodiment is not particularly limited; however, it is usually in a range of 0.1 μm to 1,000 μm.

### <Method of Producing Electronic Component Having Film on Entirety or Portion of Metal Part>

A method of producing the electronic component according to the present embodiment which includes a film on the entirety or a portion of a metal part (hereinafter, simply referred to as “production method”) includes: the first step of bringing a surface treatment agent containing a resin or a salt thereof into contact with the entirety or a portion of a metal part of an electronic component; and the second step of baking the surface treatment agent thus brought into contact (uncured film). It is noted here that, if necessary, this production method may also include the step of washing the uncured film with water between the first step and the second step.

The surface treatment agent according to the present embodiment contains a resin or a salt thereof. The resin or salt thereof contained in the surface treatment agent may be used in the form of an emulsion. The surface treatment agent may further contain, for example, an acid, an oxidizing agent, and various additives, which are known and used in surface treatment agents.

The emulsion can be obtained by, for example, dispersing the resin or salt thereof in water by a phase-inversion emulsification method. A temperature at which the resin or salt thereof is dispersed is not particularly limited; however, it is preferably 5° C. to 50° C.

The emulsion may further contain a curing agent such as a blocked polyisocyanate. In addition, a curing catalyst may be incorporated along with the curing agent. When these components are incorporated, the emulsion can be obtained by mixing the resin or salt thereof with the curing agent and the curing catalyst in advance, and subsequently dispersing the resulting mixture in water by a phase-inversion emulsification method.

The blocked polyisocyanate can be obtained by allowing a blocking agent to react with isocyanate groups of a polyisocyanate compound, thereby protecting the isocyanate groups.

Examples of the blocking agent include: lactam compounds, such as ε-caprolactam and γ-butyrolactam; oxime compounds, such as methyl ethyl ketoxime and cyclohexanone oxime; phenolic compounds, such as phenol, para-t-butyl phenol, and cresol; alcohols, such as n-butanol and 2-ethyl hexanol; and glycol ether compounds, such as ethylene glycol monobutyl ether, ethylene glycol monohexyl ether, and diethylene glycol monoethyl ether. These blocking agents may be used singly, or in combination of two or more kinds thereof, and an appropriate blocking agent(s) can be selected based on the type of the polyisocyanate compound.

As the curing catalyst, any known catalyst, examples of which include tin-based catalysts, bismuth-based catalysts, titanium-based catalysts, zirconium catalysts, amine-based catalysts, carboxylate-based catalysts, and trialkyl phosphine-based catalysts, can be used. These curing catalysts may be used singly, or in combination of two or more kinds thereof.

Examples of the above-described acid and oxidizing agent include: hydrofluoric acid and salts thereof; fluorosilicic acid and salts thereof; fluorotitanic acid and salts thereof; water-soluble iron compounds, such as iron (III) nitrate, iron (III) sulfate, iron (III) methanesulfonate, iron (III) fluoride, iron (III) chloride, and iron (III) citrate; and peroxides of acetic acid, phosphoric acid, sulfuric acid, nitric acid, hydrogen peroxide, perchloric acid, permanganic acid, and the like. These acids and oxidizing agents may be used singly, or in combination of two or more kinds thereof. Examples of the salts include: alkali metal salts, such as sodium salts and potassium salts; ammonium salts; alkanolamine salts, such as monoethanolamine salts, diethanolamine salts, triethanolamine salts, methylethanolamine salts, and dimethylethanolamine salts; alkylamine salts, such as tetramethylamine salts and tetraethylamine salts; benzylamine salts, such as methylbenzylamine salts and dimethylbenzylamine salts; and alicyclic amine salts, such as pyrrolidine salts and piperidine salts.

Examples of the additives include pH modifiers, ORP modifiers, chelating agents, anti-weathering agents, antibacterial agents, antifungal agents, pigments, fillers, rust inhibitors, pigments, dyes, film-forming aids, inorganic crosslinking agents, organic crosslinking agents (e.g., carbodiimide-based crosslinking agents, oxazoline-based crosslinking agent, and melamine-based crosslinking agents), silane coupling agents, blocking inhibitors, viscosity modifiers, leveling agents, antifoaming agents, dispersion stabilizers, light stabilizers, antioxidants, UV absorbers, inorganic fillers, organic fillers, plasticizers, lubricants, and antistatic agents. These additives may be used singly, or in combination of two or more kinds thereof.

The above-described surface treatment agent can be produced by, for example, adding to the resin or salt thereof and, if necessary, the acid, the oxidizing agent, the various additives, and the like to an aqueous medium, and mixing the resultant. The above-described emulsion may be used as the surface treatment agent, or the above-described emulsion mixed with the acid, the oxidizing agent, the various additives, and the like may be used as the surface treatment agent.

Examples of a contact method employed in the first step include, but are not limited to, a dipping (immersion) method, a coating method, a spray method, a pouring method, and an electrodeposition painting method. A temperature and a duration of contact are not particularly limited; however, they are usually in a range of 5° C. to 50° C. and a range of 0.1 seconds to 1 hour, respectively.

As for a method of baking the surface treatment agent thus brought into contact in the second step, the baking is performed, for example, in a temperature range of 100° C. to 250° C. for a duration in a range of 1 minute to 2 hours; however, the conditions are not limited thereto.

In the production method according to the present embodiment, the degreasing treatment step may be performed on the surface of the electronic component before the first step. This degreasing treatment may be performed by any known method using a degreasing treatment agent appropriate for the electronic component. Examples of the degreasing treatment agent include, but are not limited to, known acidic degreasing agents, alkaline degreasing agents, and solvent degreasing agents. Examples of a degreasing method include, but are not particularly limited to, scrub cleaning, spray cleaning (jet cleaning), and dip (immersion) cleaning.

In the production method according to the present embodiment, the water-washing step of washing the surface of the electronic component may be performed after the degreasing treatment step but before the first step, and the drying step of drying the surface of the electronic component may be further performed after the water-washing step but before the first step. As a drying method, any known method can be applied.

Moreover, the chemical conversion treatment step of forming a chemical conversion film on the metal part of the electronic component may be performed before the first step, but after the degreasing treatment step, the water-washing step, the drying step, and the like that are performed before the first step. This chemical conversion treatment is performed by bringing the electronic component into contact with a known chemical conversion treatment agent. A chemical conversion treatment method is not particularly limited, and any known method can be applied. The water-washing step may be performed after the chemical conversion treatment step but before the first step, and the drying step may be performed after the water-washing step but before the first step.

### EXAMPLES

The present invention will now be described by way of Examples and Comparative Examples. It is noted here, however, that the present invention is not limited to the below-described Examples.

### Production Example 1

To 536.0 g of N-methyl-2-pyrrolidone, 256.2 g of A1, 148.5 g of A2, 32.3 g of B1, and 26.9 g of C1 were added, and the resultant was heated to 120° C. with stirring. Subsequently, while maintaining this temperature, 0.6 g of dimethylbenzylamine was added and allowed to react for 1.5 hours. Thereafter, the resulting reaction solution was cooled to obtain an anionic epoxy resin having a solid concentration of 46.4% and a weight-average molecular weight of about 50,000. The thus obtained anionic epoxy resin in an amount of 646.6 g was weighed in other container, after which 353.4 g of deionized water was slowly added thereto, and a resin emulsion having a solid concentration of 30% was produced by a phase-inversion emulsification method.

### Production Examples 2 to 15 and 17

Resin emulsions of Production Examples 2 to 15 and 17 were obtained in the same manner as in Production Example 1, except that the added amounts (indicated in parts by mass) of the respective components were changed as shown in Table 1.

TABLE 1

| | | | | | Raw material | | Raw material | | Raw material | | Raw material | | Raw material | |
|---|---|---|---|---|---|---|---|---|---|---|---|---|---|---|
| | | | | | containing | | containing | | containing | | containing | | containing | |
| | Raw material containing | | | | structure of | | structure of | | structure of | | structure of | | structure of | |
| | structure of Formula (1) | | | | Formula (2) | | Formula (3) | | Formula (4) | | Formula (4) | | Formula (5) | |
| | | Added | | Added | | Added | | Added | | Added | | Added | | Added |
| | | amount | | amount | | amount | | amount | | amount | | amount | | amount |
| | Type | [g] | Type | [g] | Type | [g] | Type | [g] | Type | [g] | Type | [g] | Type | [g] |
| Production | A1 | 256.2 | A2 | 148.5 | B1 | 32.3 | — | — | C1 | 26.9 | — | — | — | — |
| Example 1 | | | | | | | | | | | | | | |
| Production | A1 | 307.0 | A4 | 86.0 | B1 | 38.7 | — | — | C1 | 32.3 | — | — | — | — |
| Example 2 | | | | | | | | | | | | | | |
| Production | A3 | 221.6 | A2 | 173.3 | B1 | 37.7 | — | — | C1 | 31.4 | — | — | — | — |
| Example 3 | | | | | | | | | | | | | | |
| Production | A1 | 259.7 | A2 | 150.6 | B2 | 26.4 | — | — | C1 | 27.3 | — | — | — | — |
| Example 4 | | | | | | | | | | | | | | |
| Production | A1 | 259.6 | A2 | 150.5 | — | — | B3 | 26.5 | C1 | 27.3 | — | — | — | — |
| Example 5 | | | | | | | | | | | | | | |
| Production | A1 | 257.1 | A2 | 149.0 | — | — | B4 | 30.9 | C1 | 27.0 | — | — | — | — |
| Example 6 | | | | | | | | | | | | | | |
| Production | A1 | 258.4 | A2 | 149.8 | B1 | 32.6 | — | — | — | — | C3 | 23.2 | — | — |
| Example 7 | | | | | | | | | | | | | | |
| Production | A1 | 255.1 | A2 | 147.9 | B1 | 32.2 | — | — | — | — | C4 | 28.8 | — | — |
| Example 8 | | | | | | | | | | | | | | |
| Production | A1 | 257.4 | A2 | 149.2 | — | — | B3 | 26.3 | C2 | 31.1 | — | — | — | — |
| Example 9 | | | | | | | | | | | | | | |
| Production | A1 | 261.9 | A2 | 151.8 | — | — | B3 | 26.7 | — | — | C3 | 23.5 | — | — |
| Example 10 | | | | | | | | | | | | | | |
| Production | A1 | 258.5 | A2 | 149.9 | — | — | B3 | 26.4 | — | — | C4 | 29.2 | — | — |
| Example 11 | | | | | | | | | | | | | | |
| Production | A1 | 255.0 | A2 | 149.0 | B1 | 25.9 | B3 | 7.1 | C1 | 27.0 | — | — | — | — |
| Example 12 | | | | | | | | | | | | | | |
| Production | A1 | 257.2 | A2 | 150.2 | B1 | 26.1 | B3 | 7.1 | — | — | C3 | 23.3 | — | — |
| Example 13 | | | | | | | | | | | | | | |
| Production | A1 | 260.8 | A2 | 151.2 | B1 | 32.9 | — | — | C1 | 11.0 | C3 | 14.1 | — | — |
| Example 14 | | | | | | | | | | | | | | |
| Production | A1 | 263.4 | A2 | 152.7 | — | — | B3 | 26.9 | C1 | 16.6 | C3 | 9.5 | — | — |
| Example 15 | | | | | | | | | | | | | | |
| Production | A1 | 238.9 | A2 | 114.4 | — | — | B3 | 24.4 | C1 | 25.1 | — | — | D1 | 61.2 |
| Example 16 | | | | | | | | | | | | | | |
| Production | A1 | 354.7 | A2 | 82.0 | — | — | — | — | C1 | 27.4 | — | — | — | — |
| Example 17 | | | | | | | | | | | | | | |

The symbols in Table 1 represent the following components.

### <Components A>

A1: diglycidyl ether compound of bisphenol A (jER #828EL, manufactured by Mitsubishi Chemical Corporation)
A2: bisphenol A (manufactured by Idemitsu Kosan Co., Ltd.)
A3: diglycidyl ether compound of 1,6-dihydroxynaphthalene (EPICLON HP-4032D, manufactured by DIC Corporation)
A4: resorcinol (manufactured by Tokyo Chemical Industry Co., Ltd.)

### <Components B>

B1: compound in which hydrogen atoms of three hydroxy groups of α,α,α′-tris(4-hydroxyphenyl)-1-ethyl-4-isopropylbenzene are substituted with glycidyl groups (TECHMORE VG-3101 L, manufactured by Printec Corporation)
B2: triglycidyl ether compound of 1,1,1-tris(4-hydroxyphenyl)ethane (jER #1032H60, manufactured by Mitsubishi Chemical Corporation)
B3: tetraglycidyl ether compound of 1,1′-methylene-bis(2,7-naphthalenediol) (EPICLON HP-4710, manufactured by DIC Corporation)
B4: tetraglycidyl ether compound of 1,1,2,2-tetrakis(4-hydroxyphenyl)ethane (jER #1031 S, manufactured by Mitsubishi Chemical Corporation)
   <Components C: All of which are Manufactured by Tokyo Chemical Industry Co., Ltd.>
C1: potassium hydroquinone sulfonate
C2: sodium 2,3-dihydroxynaphthalene-6-sulfonate
C3: sodium 4-aminobenzene sulfonate
C4: sodium 2-amino-1-naphthalene sulfonate

### <Component D>

D1: dicarboxylic acid compound (HARIDIMER 270S, manufactured by Harima Chemicals Group, Inc.)

### <Blocked Polyisocyanate>

To 452.3 g of a polymethylene polyphenyl polyisocyanate (COSMONATE M-200, manufactured by Mitsui Chemicals, Inc.), 77.1 g of methyl isobutyl ketone was added, and the resultant was heated to 70° C., after which 470.7 g of butyl cellosolve was slowly added dropwise, followed by heating to 90° C. Subsequently, these materials were allowed to react for 12 hours at 90° C. to obtain a blocked polyisocyanate curing agent in which isocyanate groups were completely blocked. Blocking of isocyanate groups was verified by infrared absorption spectrometry based on whether or not absorption attributed to unreacted an isocyanate group was observed.

### Production Example 16

An anionic epoxy resin was obtained in the same manner as in Production Example 1, except that the added amounts of the respective components were changed as shown in Table 1. The thus obtained anionic epoxy resin in an amount of 442.1 g was mixed with 97.7 g of the above-synthesized blocked polyisocyanate and 6.7 g of dioctyl tin (NEOSTANN U-820, manufactured by Nitto Kasei Co., Ltd.), after which 453.5 g of deionized water was slowly added thereto, and a resin emulsion having a solid concentration of 30% was produced by a phase-inversion emulsification method.

### <Surface Treatment Agents>

To 333.0 g of the resin emulsion of Production Example 1, 5.5 g of a black pigment (SANDYE DP BLACK CN, manufactured by Sanyo Color Works, Ltd.), 53.0 g of NSD-300 (manufactured by Nihon Parkerizing Co., Ltd.), and 608.5 g of deionized water were added, and the pH of the resultant was adjusted to be 3.5 with a 25%-by-mass aqueous sodium hydroxide solution, after which the ORP (oxidation-reduction potential) was adjusted to be 380 to 420 mV with a hydrogen peroxide solution, whereby a surface treatment agent having a solid concentration of 10% was prepared. In the same manner, surface treatment agents were prepared using the resin emulsions of Production Examples 2 to 17.

Further, a surface treatment agent containing an acryl-ester copolymer was prepared in the same manner as in Production Example 1, except that a resin emulsion of an acryl-ester copolymer (NIPOL SX1706A, manufactured by Zeon Corporation) was used such that the surface treatment agent had a solid concentration of 10%.

### <Metal Material>

A cold-rolled steel plate (SPCC-SD), an aluminum alloy plate (A5052), and a copper alloy plate (C1020P) were used as metal materials.

### <Degreasing Treatment>

The surfaces of the metal materials were degreased by spraying thereto an alkaline degreasing agent [a degreasing agent obtained by mixing the agents A and B of FINE CLEANER E2001 (manufactured by Nihon Parkerizing Co., Ltd.) with water at concentrations of 13 g/kg and 7 g/kg, respectively] for 2 minutes at 45° C.

### <Surface Treatment>

The thus degreased metal materials were each immersed in the above-prepared surface treatment agent at 25° C. for 1 minute and then washed with water. The thus water-washed metal materials were backed at 180° C. (PMT: highest temperature of each metal material during baking) for 20 minutes to obtain test plates each having a 20 μm-thick film on the surface.

The resin emulsions in the respective surface treatment agents and the metal materials that were used in Examples and Comparative Examples are as shown in Table 2.

### <Evaluation Tests>

Various evaluation tests were conducted using the thus produced test plates. The results thereof are shown in Table 2.

### <Insulation Test>

The dielectric breakdown voltage of the film of each test plate was measured using a withstand voltage tester (TOS9201, manufactured by Kikusui Electronics Corporation). The measurement was performed at an initial voltage of 50 V, a voltage increase rate of 50 V/sec, and a cut-off current of 1.0 mA. The insulation of the film was evaluated based on the dielectric breakdown voltage per unit film thickness, which was calculated by dividing the measured dielectric breakdown voltage by the thickness of the film.

### <High-Temperature High-Humidity Test>

Each test plate was left to stand for 3,000 hours in a thermo-hygrostat chamber (ETAC HIFLEX, manufactured by Kusumoto Chemicals, Ltd.) set at a temperature of 85° C. and a relative humidity of 85%. The dielectric breakdown voltage per unit film thickness of the test plate was measured at each time point of before leaving the test plate in the thermo-hygrostat chamber (initial) and after the 3,000 hours, and a ratio of the dielectric breakdown voltage after the 3,000 hours with respect to the initial dielectric breakdown voltage of the film (insulation retention rate after high-temperature high-humidity test) was calculated. Based on the thus obtained ratio, the high-temperature high-humidity test was evaluated by the following criteria, and an evaluation of A or B was regarded as satisfactory.
A: The insulation retention rate after the high-temperature high-humidity test was 0.9 or higher.
B: The insulation retention rate after the high-temperature high-humidity test was 0.6 or higher but lower than 0.9.
C: The insulation retention rate after the high-temperature high-humidity test was lower than 0.6.

### <Thermal Cycle Test>

Each test plate was left to stand in a temperature cycle tester (ETAC WINTEC, manufactured by Kusumoto Chemicals, Ltd.), and the temperature inside the tester was changed in the following order of 1. to 4. (the temperature changes of 1. to 4. were defined as one cycle).
1. Maintain the test plate at −50° C. for 30 minutes.
2. Heat the test plate to 150° C.
3. Maintain the test plate at 150° C. for 30 minutes.
4. Cool the test plate to −50° C.

The dielectric breakdown voltage per unit film thickness of the test plate was measured at each time point of before leaving the test plate in the temperature cycle tester (initial) and after 1,000 cycles, and a ratio of the dielectric breakdown voltage after 1,000 cycles with respect to the initial dielectric breakdown voltage of the film (insulation retention rate after thermal cycle test) was calculated. Based on the thus obtained ratio, the thermal cycle test was evaluated by the following criteria, and an evaluation of A or B was regarded as satisfactory.
A: The insulation retention rate after the thermal cycle test was 0.9 or higher.
B: The insulation retention rate after the thermal cycle test was 0.6 or higher but lower than 0.9.
C: The insulation retention rate after the thermal cycle test was lower than 0.6.

### <High-Temperature Exposure Test>

Each test plate was left to stand for 3,000 hours in an oven set at 150° C. The dielectric breakdown voltage per unit film thickness of the test plate was measured at each time point of before leaving the test plate in the oven (initial) and after the 3,000 hours, and a ratio of the dielectric breakdown voltage after the 3,000 hours with respect to the initial dielectric breakdown voltage of the film (insulation retention rate after high-temperature exposure test) was calculated. Based on the thus obtained ratio, the high-temperature exposure test was evaluated by the following criteria, and an evaluation of A or B was regarded as satisfactory.
A: The insulation retention rate after the high-temperature exposure test was 0.9 or higher.
B: The insulation retention rate after the high-temperature exposure test was 0.6 or higher but lower than 0.9.
C: The insulation retention rate after the high-temperature exposure test was lower than 0.6.

TABLE 2

| | | | High-temperature | | | | | |
|---|---|---|---|---|---|---|---|---|
| | | | high-humidity test | | | | Thermal cycle test | |
| | | | Dielectric | | | | Dielectric | |
| | | | breakdown voltage | | | | breakdown voltage | |
| | Resin emulsion in | | [V/μm] | | Insulation | | [V/μm] | |
| | surface treatment | Metal | Before | After | retention | | Before | After |
| | agent | material | test | test | rate | Evaluation | test | test |
| Example1 | Production | SPCC-SD | 111 | 105 | 0.95 | A | 107 | 95 |
| | Example 1 | | | | | | | |
| Example2 | Production | SPCC-SD | 107 | 91 | 0.85 | B | 113 | 96 |
| | Example 2 | | | | | | | |
| Example3 | Production | SPCC-SD | 100 | 87 | 0.87 | B | 105 | 91 |
| | Example 3 | | | | | | | |
| Example4 | Production | SPCC-SD | 105 | 99 | 0.94 | A | 104 | 93 |
| | Example 4 | | | | | | | |
| Example5 | Production | SPCC-SD | 115 | 100 | 0.87 | B | 109 | 104 |
| | Example 5 | | | | | | | |
| Example6 | Production | SPCC-SD | 104 | 83 | 0.80 | B | 104 | 83 |
| | Example 6 | | | | | | | |
| Example7 | Production | SPCC-SD | 104 | 96 | 0.92 | A | 107 | 87 |
| | Example 7 | | | | | | | |
| Example8 | Production | SPCC-SD | 106 | 102 | 0.96 | A | 104 | 84 |
| | Example 8 | | | | | | | |
| Example9 | Production | SPCC-SD | 117 | 111 | 0.95 | A | 103 | 97 |
| | Example 9 | | | | | | | |
| Example10 | Production | SPCC-SD | 103 | 94 | 0.91 | A | 105 | 99 |
| | Example 10 | | | | | | | |
| Example11 | Production | SPCC-SD | 102 | 95 | 0.93 | A | 109 | 99 |
| | Example 11 | | | | | | | |
| Example12 | Production | SPCC-SD | 105 | 100 | 0.95 | A | 102 | 97 |
| | Example 12 | | | | | | | |
| Example13 | Production | SPCC-SD | 103 | 95 | 0.92 | A | 108 | 100 |
| | Example 13 | | | | | | | |
| Example14 | Production | SPCC-SD | 101 | 97 | 0.96 | A | 101 | 86 |
| | Example 14 | | | | | | | |
| Example15 | Production | SPCC-SD | 114 | 107 | 0.94 | A | 110 | 105 |
| | Example 15 | | | | | | | |
| Example16 | Production | SPCC-SD | 108 | 103 | 0.95 | A | 110 | 103 |
| | Example 16 | | | | | | | |
| Example17 | Production | A5052 | 109 | 104 | 0.95 | A | 104 | 97 |
| | Example 9 | | | | | | | |
| Example18 | Production | C1020P | 112 | 106 | 0.95 | A | 106 | 101 |
| | Example 9 | | | | | | | |
| Comprative | Acryl-ester | SPCC-SD | 101 | 20 | 0.20 | C | 107 | 27 |
| Example1 | copolymer | | | | | | | |
| Comprative | Production | SPCC-SD | 107 | 37 | 0.35 | C | 102 | 21 |
| Example2 | Example 17 | | | | | | | |

| | | | High-temperature | | | |
|---|---|---|---|---|---|---|
| | | | exposure test | | | |
| | | | Dielectric | | | |
| | Thermal cycle test | | breakdown voltage | | | |
| | Insulation | | [V/μm] | | Insulation | |
| | retention | | Before | After | retention | |
| | rate | Evaluation | test | test | rate | Evaluation |
| Example1 | 0.89 | B | 110 | 94 | 0.85 | B |
| Example2 | 0.85 | B | 115 | 98 | 0.85 | B |
| Example3 | 0.87 | B | 109 | 92 | 0.84 | B |
| Example4 | 0.89 | B | 107 | 95 | 0.89 | B |
| Example5 | 0.95 | A | 115 | 110 | 0.96 | A |
| Example6 | 0.80 | B | 100 | 79 | 0.79 | B |
| Example7 | 0.81 | B | 104 | 87 | 0.84 | B |
| Example8 | 0.81 | B | 111 | 97 | 0.87 | B |
| Example9 | 0.94 | A | 110 | 107 | 0.97 | A |
| Example10 | 0.94 | A | 107 | 90 | 0.84 | B |
| Example11 | 0.91 | A | 103 | 82 | 0.80 | B |
| Example12 | 0.95 | A | 105 | 85 | 0.81 | B |
| Example13 | 0.93 | A | 113 | 93 | 0.82 | B |
| Example14 | 0.85 | B | 108 | 93 | 0.86 | B |
| Example15 | 0.95 | A | 104 | 82 | 0.79 | B |
| Example16 | 0.94 | A | 110 | 105 | 0.95 | A |
| Example17 | 0.93 | A | 114 | 107 | 0.94 | A |
| Example18 | 0.95 | A | 113 | 108 | 0.96 | A |
| Comprative | 0.25 | C | 104 | 32 | 0.31 | C |
| Example1 | | | | | | |
| Comprative | 0.21 | C | 107 | 33 | 0.31 | C |
| Example2 | | | | | | |

The present invention has been described above in detail referring to concrete Examples thereof; however, it is obvious to those skilled in the art that various modifications and changes can be made without departing from the spirit and the scope of the present invention.

1. An electronic component, comprising:
a metal part; and
a film on the entirety or a portion of the metal part,
wherein the film comprises an anionic epoxy resin or a salt thereof, which comprises a structural unit represented by the following Formula (1), at least one of structural units represented by the following Formulae (2) and (3), and at least one of structural units represented by the following Formulae (4) and (5): 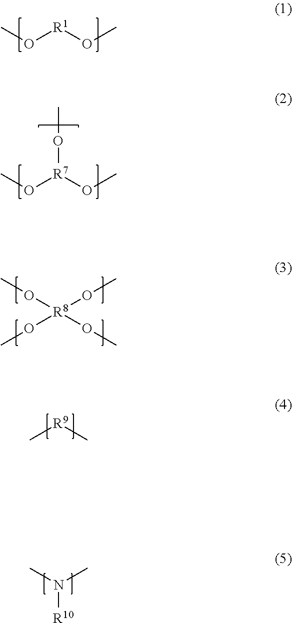
[in Formula (1), R¹ represents a structure represented by the following Formula (1a), (2a), or (3a); in Formula (2), R⁷ represents a structure represented by the following Formula (4a) or (5a); in Formula (3), R⁸ represents a structure represented by the following Formula (6a) or (7a); in Formula (4), R⁹ represents a structure represented by the following Formula (8a) or (9a); and, in Formula (5), R¹⁰ represents a structure represented by the following Formula (10a) or (11a)] 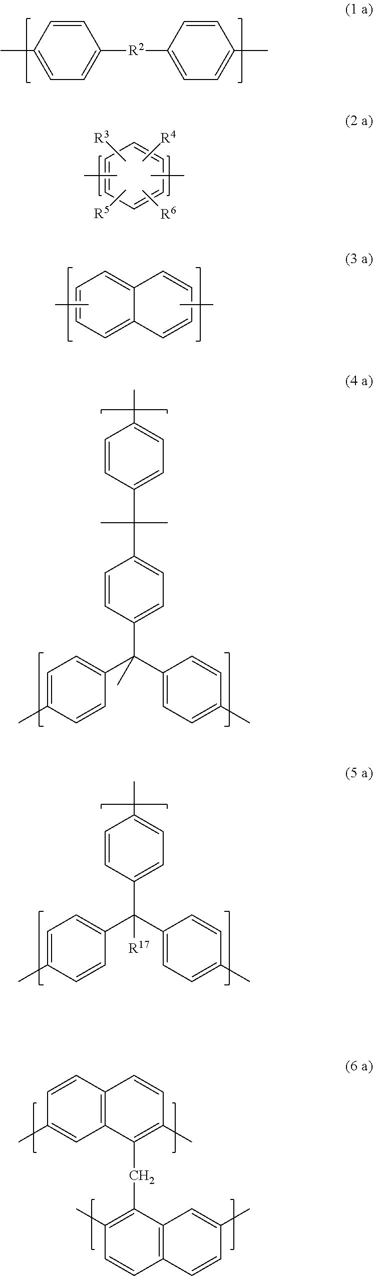 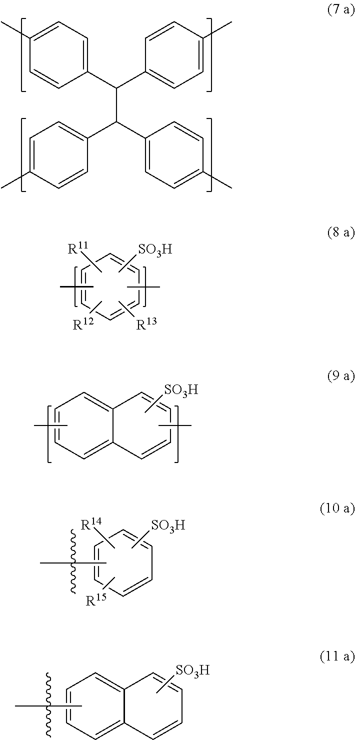
[in Formula (1a), R² represents a single bond, C(CH₃)₂, CH(CH₃), CH₂, S, O, or SO₂; in Formula (2a), R³ to R⁶ each independently represent a hydrogen atom, a methyl group, an alkylcarbonyl group, an alkoxy group, or an alkoxycarbonyl group; in Formula (5a), R¹⁷ represents a hydrogen atom or an alkyl group; in Formula (8a), R¹¹ to R¹³ each independently represent a hydrogen atom, a methyl group, or an alkoxy group; and, in Formula (10a), R¹⁴ and R¹⁵ each independently represent a hydrogen atom, a methyl group, or an alkoxy group].

2. The electronic component according to claim 1, which is selected from the group consisting of an electronic component, a bus bar, a reactor, an electric wire, and a sintered magnet, which constitute a motor.
